(19) United States
(12) Patent Application Publication
(10) Pub. No.: US 2026/0089290 A1
(43) Pub. Date: Mar. 26, 2026

(54) Energy Efficient Adaptive Edge-Dimming

(71) Applicant: ATI Technologies ULC, Markham (CA)

(72) Inventor: Wing-Chi Chow, Toronto (CA)

(21) Appl. No.: 18/896,062

(22) Filed: Sep. 25, 2024

(51) Int. Cl. H04N 5/14; H04N 21/431

(52) U.S. Cl. CPC H04N 5/14; H04N 21/4312

(57) ABSTRACT

Systems and methods described for adaptive edge dimming are disclosed. A video processing system analyzes video frames in a video stream, and determines display settings corresponding to a target display device. The system further analyzes aspect ratio of the frame, excluding any black bars, with respect to aspect ratio of the display (or playback window in windowed mode). Based on this comparison the system adaptively applies edge dimming to exclude the black bars. Edge dimming can also be implemented as a hybrid solution, wherein the source detects the region for edge-dimming and transmits metadata to the sink device for applying the edge-dimming.

### BACKGROUND

### Description of the Related Art

Edge dimming is a technology used in display devices, primarily in LED-backlit LCDs, to enhance contrast and improve power efficiency. It involves controlling the brightness of specific edge-lit LED zones in a display. This technique is different from full-array local dimming, where the entire backlight is divided into multiple zones that can be individually controlled for more precise lighting.

In edge-lit displays, the LEDs are positioned along the edges of the screen, typically either along the sides or the top and bottom. Light is then diffused across the screen to illuminate the image. Edge dimming adjusts the brightness of these edge LEDs based on the content being displayed. For example, in darker scenes, the LED backlight near the edges is dimmed to reduce light leakage, making dark areas appear more black. A video processing unit uses image analysis algorithms to determine which parts of the screen should be darker or brighter. It sends signals to the display to adjust the brightness of the edge LEDs accordingly, based on the scene's content.

With emissive displays such as OLEDs or non-emissive displays with local dimming, power can be reduced by dimming the image around the edges of the display. This dimming is subtle and barely noticeable to the end user, but can save substantial display panel power. Traditional edge dimming solutions may be non-adaptive, i.e., applied to full-screen or window-adaptive, i.e., applied to edges of the window. These may work well when the image is full-screen (i.e., occupies the full resolution of the display), however, they may not be as efficient when the image is not full-screen, as is common with video playback. Further, if letterboxing, pillarboxing, or windowboxing is used, non-adaptive edge-dimming may not work well, both from a power and picture quality perspective.

In view of the above, improved systems and methods for edge dimming are needed.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one implementation of a computing system.

FIG. 2 illustrates a video processing system.

FIGS. 3a-3c illustrate a block diagram of application of adaptive edge dimming for a video frame displayed in a full screen mode.

FIGS. 4a-4b illustrate a block diagram of application of adaptive edge dimming for a video frame displayed in a windowed mode.

FIG. 5 illustrates adaptive edge dimming applied to multiple video streams displayed simultaneously.

FIG. 6 illustrates a method for generating modified video frames.

FIG. 7 illustrates a method for applying edge dimming to video streams based on one or more conditions.

### DETAILED DESCRIPTION OF IMPLEMENTATIONS

In the following description, numerous specific details are set forth to provide a thorough understanding of the methods and mechanisms presented herein. However, one having ordinary skill in the art should recognize that the various implementations may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Systems and methods for adaptive edge dimming are described. The techniques described herein allow for adaptive edge dimming based on the contents of video frames. A video processing system analyzes video frames in a video stream, and determines display settings corresponding to a target display device. These settings can include a full screen mode or a windowed mode. The system further analyzes the aspect ratio of the frame, excluding any black bars with respect to the aspect ratio of the display (or playback window in windowed mode). Based on this comparison the system adaptively applies edge dimming to exclude the black bars. In one or more implementations, black bars can be used to preserve an original aspect ratio of a video, e.g., using methods like letterboxing, pillarboxing, or windowboxing. These techniques include displaying black bars along one or more boundaries surrounding the video. These black bars can also be used to display video subtitles and closed-captioning. Further, in some videos, black bars can be used as part of the design, either for emphasis or to make text elements stand out. This can include call-to-action banners or text-heavy graphics.

The solutions described herein can be implemented in a source device (video processing systems) or a sink device (display devices). In some implementations, edge dimming can also be implemented as a hybrid solution, wherein the source detects the region for edge-dimming and transmits metadata to the sink device for applying the edge-dimming. Unlike non-adaptive solutions, methods described herein are used to apply adaptive edge dimming to reduce power and improve picture quality for full-screen (or windowed) video playback, even when letterboxing (or pillarboxing or windowboxing) is detected. Further, for picture quality reasons, edge-dimming needs be applied along all visible edges which may not be possible with non-adaptive solutions, but is possible with adaptive edge dimming as described herein.

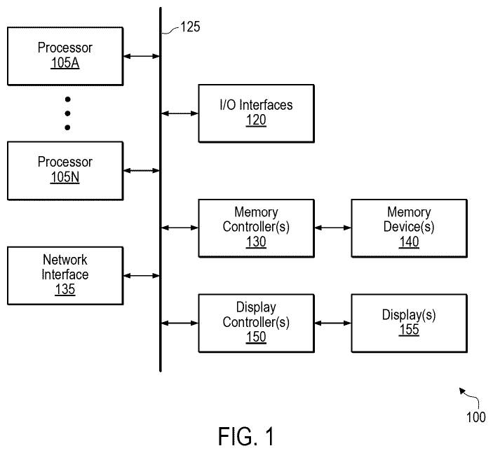

Referring now to FIG. 1, a block diagram of one implementation of a computing system 100 is shown. In an implementation, computing system 100 is configured to, amongst other functionalities, process data, such as but not limited to, unprocessed image data received from one or more imaging devices. The system 100 is configured to identify pixels in a raw image pattern and process the raw image pattern to create display-ready images. Additionally, the system 100 is configured to process data pertaining to static images and dynamic images (like videos) for a diverse range of camera-enabled devices, such as digital cameras, electronic devices with built-in digital cameras (e.g., mobile devices and laptop computers), security or video surveillance setups, medical imaging systems, and other devices operating in similar contexts.

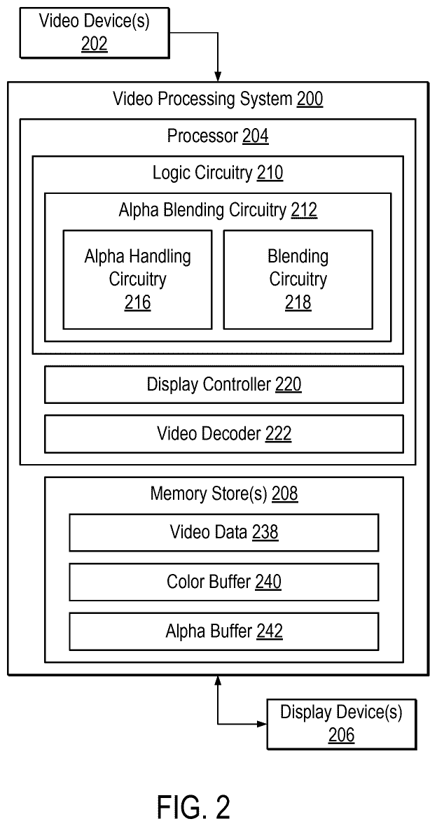

In one or more implementations, the system 100 encompasses a video processing system configured to handle video playback data. This includes decompressing, processing, optionally compressing, and transmitting video streams to display device(s) 155. The system 100 receives video data from a variety of sources such as video files, live streaming, or a video feed. The video data is received in an uncompressed or compressed format. The system 100 decodes the data to prepare the data for transmission. This involves scaling, color correction, and optimizing the frame rate to ensure smooth playback. Further, to reduce the amount of data needed to transmit video to display device(s) 155, methods such as Display Stream Compression (DSC) may be used to reduce the data size while maintaining visually lossless quality. The video data (with or without compression) is sent to the display device(s) 155 over interfaces like High-Definition Multimedia Interface (HDMI), DisplayPort (DP), Embedded DisplayPort (eDP), or mobile industry processor interface Display Serial Interface (MIPI DSI). In an implementation, a display pipeline of the display device(s) 155 receives the decoded data and uses the decoded data to render the video on the screen. In one or more implementations, metadata about display data, such as details on pixel brightness, alpha blending, color correction, etc. is also sent from the system 100 to the display device(s) 155. This metadata is utilized by the display device(s) 155 in processing the video stream to create a final display video. These and other implementations are explained in detail with respect to subsequent FIGS. 2 to 7.

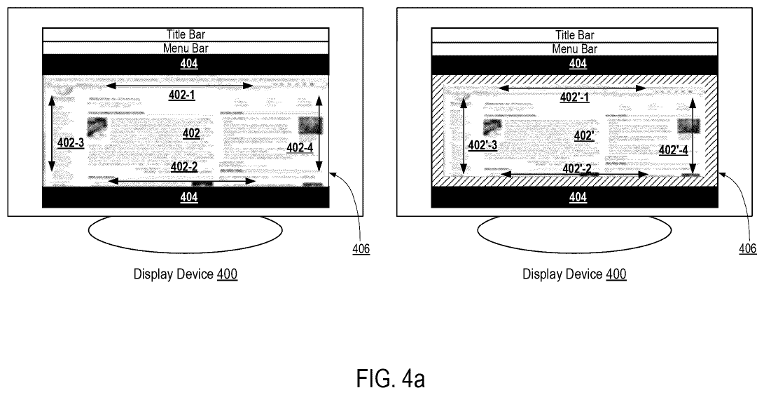

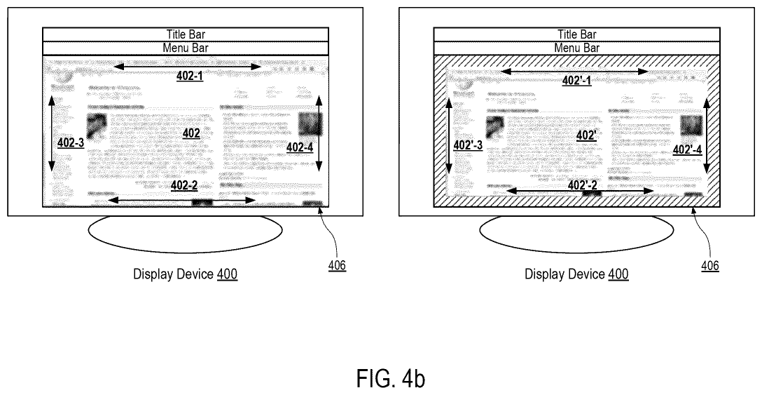

In one implementation, computing system 100 includes at least processors 105A-N, input/output (I/O) interfaces 120, bus 125, memory controller(s) 130, network interface 135, memory device(s) 140, display controller(s) 150, and display(s) 155. In other implementations, computing system 100 includes other components and/or computing system 100 is arranged differently. Processors 105A-N are representative of any number of processors which are included in system 100. In several implementations, one or more of processors 105A-N are configured to execute a plurality of instructions to perform functions as described with respect to FIGS. 4-8 herein.

In one implementation, processor 105A is a general-purpose processor, such as a central processing unit (CPU). In one implementation, processor 105N is a data parallel processor with a highly parallel architecture. Data parallel processors include graphics processing units (GPUs), digital signal processors (DSPs), field programmable gate arrays (FPGAs), application specific integrated circuits (ASICs), and so forth. In some implementations, processors 105A-N include multiple data parallel processors. In one implementation, processor 105N is a GPU which provides pixels to display controller 150 to be driven to display 155.

Memory controller(s) 130 are representative of any number and type of memory controllers accessible by processors 105A-N. Memory controller(s) 130 are coupled to any number and type of memory devices(s) 140. Memory device(s) 140 are representative of any number and type of memory devices. For example, the type of memory in memory device(s) 140 includes Dynamic Random Access Memory (DRAM), Static Random Access Memory (SRAM), NAND Flash memory, NOR flash memory, Ferroelectric Random Access Memory (FeRAM), or others.

I/O interfaces 120 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices (not shown) are coupled to I/O interfaces 120. Such peripheral devices include (but are not limited to) displays, keyboards, mice, printers, scanners, joysticks or other types of game controllers, media recording devices, external storage devices, network interface cards, and so forth. Network interface 135 is used to receive and send network messages across a network.

In various implementations, computing system 100 is a computer, laptop, mobile device, game console, television, server, streaming device, wearable device, or any of various other types of computing systems or devices. It is noted that the number of components of computing system 100 varies from implementation to implementation. For example, in other implementations, there are more or fewer of each component than the number shown in FIG. 1. It is also noted that in other implementations, computing system 100 includes other components not shown in FIG. 1. Additionally, in other implementations, computing system 100 is structured in other ways than shown in FIG. 1.

Turning now to FIG. 2, an implementation of a video processing system 200 is described. The video processing system 200 (or simply “system 200”) is configured to receive video playback data (e.g., encoded video frames) from a variety of video devices 202. These devices 202 can send real-time video streams or recorded content, which can be decoded by the system 200 (e.g., by means of a decoder 222), and the decoded frames are stored in a memory store 208 as video data 238. A display controller 220 reads the decoded frame data from the memory store 208 and transmits video signals to the display device(s) 206. In one or more implementations, before transmitting decoded frames to the display device(s), the system 200 processes the frames, e.g., to apply color correction, improve video quality, apply format compatibility, or for performing video analytics, etc.

The video playback data is received from multiple sources or devices 202, each including different formats, resolutions, and/or streaming protocols. In one implementation, the system 200 is compatible with various standards, like HDMI, IP video streams, or wireless transmission protocols, to communicate with each device 202. The devices 202 can include devices that stream video to larger displays or recording systems using wireless protocols like Wi-Fi or Bluetooth or wired connections such as HDMI, DisplayPort, USB-C, or Ethernet. The devices 202 can include streaming devices, DVD players, Blu-Ray players, file(s) from a storage device such as a hard disk drive (HDD), or USB-memory device, etc. In some implementations, the devices 202 output video via ports like HDMI, DisplayPort, or USB, as well as stream video via services or custom applications. In other implementations, devices 202 can also include one or more imaging devices such that unprocessed video data is received from these devices by the processor 204. This data, along with decoded video frames is stored as video data 238 in memory store 208. In this implementation, the data can at least include pixel values including information pertaining to color and brightness of each pixel. In most cases, this information includes either red, green, and blue (RGB) or luma, blue-difference, red-difference (YCbCr) channel values. In an implementation, this data is stored as color buffer 240.

The system 200 further includes one or more central and/or graphics processing unit or other processing circuitry (processor 204) and one or more memory stores 208. Display device(s) 206, such as monitors, televisions, or other devices (e.g., LCD or OLED devices) are connected to (or integral to) the video processing system 200. The processor 204, memory store 208, and/or display device(s) 206 are each configured to communicate with other components of the system 200 through, for instance, a bus, wires, or other connection methods. In various implementations, the display device(s) 206 is either integrated within the system 200 or functions separately from it.

As depicted in FIG. 2, a processor 204 includes logic circuitry 210, which further includes alpha blending circuitry 212. The alpha blending circuitry 212 includes an alpha handling circuitry 216 and a blending circuitry 218. The processor 204 further includes video decoder 222. It should be understood that any of these circuitries may not be confined to a single circuitry, but could instead involve tasks distributed across multiple circuitries, all of which contribute to the operation and control of the respective component.

The encoded frames are stored in the memory store 208 and further processed by the decoder 222. In one or more implementations, one or more operations of the decoder 222 can be executed using part of software or hardware (such as a GPU or dedicated video decoding hardware). The decoder 222 receives the video data (e.g., encoded frames) and transforms the data back into its original form for display. The decoder 222 decodes each frame from the compressed format back into uncompressed video data. In one example, encoded video frames often include keyframes (complete frames) and delta frames (predictive frames that store only changes from previous frames). The decoder 222 reconstructs the full image for each frame using this information. Once video frames are decoded by the decoder 222, these decoded frames are stored in memory store 208. The decoded frames are read from the memory store 208 by the display controller 220, and passed through a rendering circuitry (not shown). In one example, the rendering circuitry can be a part of a display pipeline. The decoded video frames are inputted to display pipeline(s) internal to the display device(s) 206.

In an implementation, before decoded frames are conveyed to the display device(s) 206, additional processing may be applied. This can include adjusting color profiles to match display capabilities (e.g., sRGB, HDR), or a scaling operation when decoded video resolution is different from the display resolution. Further, edge-dimming can be applied to the decoded video frame, e.g., to alter the backlight for certain regions of the display. In an example, the additional processing further includes transforming color signals in a video signal, e.g., from YCbCr to RGB formats. A display pipeline internal to the display controller 220 can perform a YCbCr to RGB conversion to transform color information in video frames into a format suitable for display on screens, e.g., using the RGB color model. In the YCbCr model, “Y” represents the luminance (brightness) of a video frame or image, dictating how light or dark a pixel is. Further, “Cb” and “Cr” are chrominance components. “Cb” represents the difference between the blue component and the luminance, while “Cr” represents the difference between the red component and the luminance. These two capture the color information.

In the RGB model, colors are created by mixing different intensities of Red, Green, and Blue. This model is used by most display device(s) 206 (monitors, TVs, etc.). In one implementation, video data is transmitted by the devices 202 to the system 200 in YCbCr format to reduce the amount of data needed to represent color. However, most modern display device(s) 206 require RGB to show the image. The display controller 220 converts video data in YCbCr format into RGB format. The display controller 220 is configured to translate Y, Cb, and Cr values into Red, Green, and Blue values. In an implementation, the “Y” value influences all three color values (R, G, B), as it represents brightness. Further, “Cb” adjusts the amount of blue, and “Cr” adjusts the amount of red. The green component is derived from the interaction of all three Y, Cb, and Cr values. When the controller 220 converts from YCbCr to RGB, the brightness and color information for the image is separated and then combined in a manner that can be used by a display device(s) 206. This is done to ensure that the colors look natural on the screen. The resultant RGB data is stored in RGB buffer 240.

In one or more implementations, display device(s) 206 can include emissive displays such as Organic Light Emitting Diodes (OLEDs) or non-emissive displays (LCD monitor or TV screen). When the display device(s) 206 operates in a power saving mode, power can be reduced by dimming a video frame around the edges of the display. This is known as “edge dimming.” This dimming is subtle, and barely noticeable to an end user, however, can save substantial display panel power. In traditional edge dimming techniques, power savings are achieved using non-adaptive edge-dimming. Non-adaptive edge-dimming, particularly in LED and LCD displays, is used to improve contrast and reduce power consumption by dimming the backlight around the edges of the display screen. This is a static or uniform method where the edge lighting is dimmed consistently across the screen, regardless of the specific content being displayed.

In some implementations, non-adaptive edge dimming can work well when the video frame is displayed in a full-screen mode (i.e., occupies the full resolution of the display device(s) 206). However, these methods may not work as well when the frame is not full-screen, e.g., as is common with video streams, when the video aspect ratio does not match the display aspect ratio. Further, in some cases, to preserve the original aspect ratio of a video, techniques like letterboxing, pillarboxing, or windowboxing may be used. These techniques include displaying black bars alone one or more boundaries of the display device(s) 206 to preserve the original aspect ratio of the video being displayed. In some implementations, with letterboxing, pillarboxing, or windowboxing, non-adaptive edge-dimming may not work well, both from a power reduction and picture quality perspective.

In multiple implementations, in order to realize efficient power savings while maintaining video playback quality, systems and methods for performing adaptive edge-dimming based on display device settings and frame content are described herein. In one such implementation, the system 200 first obtains data pertaining to display settings and/or other characteristics from the display device(s) 206. In one example, this data is obtained as Extended Display Identification Data (EDID). In an implementation, during a boot process, the system 200 establishes a connection with connected or integrated displays (such as display device(s) 206). The video source (e.g., graphics card or integrated GPU) reads the EDID from the display to obtain display data, including but not limiting to, resolution, frame rate, vendor specifications, color characteristics, timing descriptors, and the like. In other implementations, the system 200 can also identify such information, e.g., by means of DisplayID and HDMI Vendor-Specific InfoFrames (VSIF). In an implementation, this data is stored in an internal system memory, or one or more registers in a display microcontroller (e.g., display controller 150). Other implementations are contemplated.

In one implementation, the system 200 is configured to periodically query the display device(s) 206 for change in EDID. For instance, the system 200 can periodically request the display device(s) 206 for the EDID and compare the received data with previously stored EDID. If any changes are identified, the EDID is updated and the updated data is stored in memory. In another implementation, display interfaces, such as HDMI and DisplayPort, can include a Hot Plug Detect (HPD) pin, such that when a display is connected or disconnected, the HPD signal changes state (e.g., from low to high or high to low). This triggers the system 200 in the system 200 to re-read the EDID from the connected display device(s) 206. Further, a change in HPD signal can further trigger the system 200 to identify that a new display may have been connected and request the updated EDID for the newly connected display device. Other implementations of periodically checking for updated EDID are possible and are contemplated.

In an implementation, using the information obtained from the display device(s) 206, the system 200 is configured to determine whether one or more conditions are met at a time video frames are displayed on the display device(s) 206. For example, the system 200 can determine if the display device(s) 206 is in a power saving mode. In another example, the system 200 can further determine whether an application(s) is active on the display device(s) 206 that is requesting one or more video streams to be the displayed on the display device(s) 206, e.g., video playback or video conferencing applications. The system 200 can further determine whether the video application is currently operating in a full-screen mode or a windowed mode.

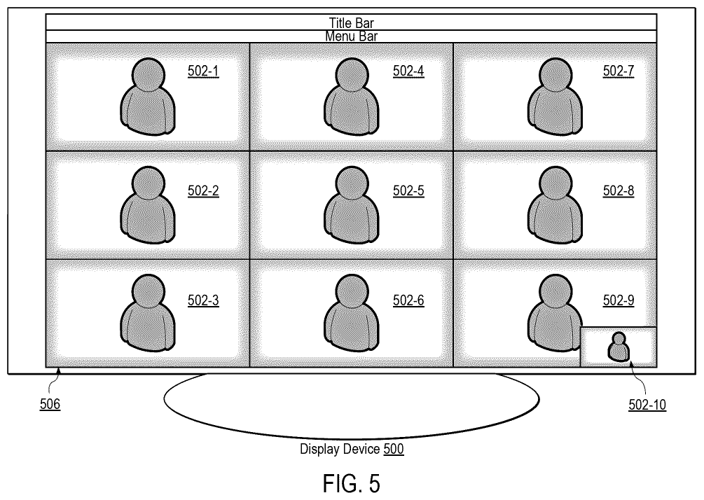

In a video playback implementation, the video processing system 200 can be an internal part of a computing system such as a laptop or a personal computer. In such implementations, when video playback is initiated from the system 200 to one or more of the display device(s) 206 (e.g., laptop screen), the system 200 renders video frames for display on the display device(s) 206. The system 200 further analyzes the video frames in real-time to cause adjustments to the frame characteristics (e.g., modification of pixel values) based on current display settings and content of video frames. In one implementation, these adjustments are made on a frame-by-frame basis. For instance, video frames can be modified when one or more display conditions are met. In one such condition, if an video player application executing on the system 200 is rendering video playback in full screen mode, and the system 200 identifies that a video aspect ratio of a given video frame does not match a display aspect ratio corresponding to the display device(s) 206 (e.g., in case of letterboxing), the system 200 modifies the video frame by applying edge dimming. Edge dimming can be applied by adjusting brightness of selected pixels along each boundary (i.e., edge) of the video frame. This modification is performed in real-time, e.g., as the video frame is being rendered. In another example, when the video playback application is operating in a windowed mode, and the system 200 identifies that a video aspect ratio of a video frame matches an aspect ratio of a playback window used to display the frame, the system 200 causes modification of pixels for the playback window (e.g., causes reduction of brightness of pixels along each boundary of the playback window). In another implementation, in cases where multiple video frames are displayed (e.g., in a video conferencing application), the system 200 can modify each individual video frame based on identified settings of the display device(s) 206 (as described in FIG. 5). The system 200 continues to modify rendered video frames, e.g., as long as the display device(s) 206 is operating in a power saving mode and/or one or more other conditions are fulfilled. Any observed changes to the display device(s) 206 settings triggers further modifications to the video frames accordingly.

In one or more implementations, the edge dimming is performed by extracting pixel data of video frames while they are being rendered, and modifying these pixel values based on the display conditions and the content of the frames. In one implementation, reduction in pixel brightness is performed by means of alpha blending. In this implementation, each pixel has a color value (RGB) and an alpha value (transparency). To perform edge dimming, alpha handling circuitry 216 reduces the alpha value of each pixel gradually towards the edges of an object in the frame. This creates an effect of the object fading out at the edges, making them appear dimmed or soft. The alpha value at each pixel is determined by how close the pixel is to the edge. For each pixel in the object, the alpha handling circuitry 216 first calculates the pixel's distance from the nearest edge. Pixels at the center of the object are farther from the edge, and pixels closer to the boundary have a shorter distance. This distance is used to determine the alpha value. Pixels at the edges have a lower alpha value (nearer 0, making them more transparent), while pixels near the center have a higher alpha value (near 1, making them more opaque). Based on the calculated alpha value, the blending circuitry 218 blends the object with the background, e.g., black. The edges, with lower alpha values, appear dimmer and more transparent, creating a smooth transition into the background. A non-limiting example of reduction in pixel brightness using alpha blending is shown using the below pseudocode.

```
for each pixel:
  if black bar
    alpha = 1
  else if (dx ≥ t) and (dy ≥ t)
    alpha = 1
  else if (dx < t) and (dy ≥ t)
    alpha = 1 − (md * (t − dx)/t)
  else if (dx ≥ t) and (dy < t)
    alpha = 1 − (md * (t − dy)/t)
  else if (dx ≤ dy)
    alpha = 1 − (md * (t − dx)/t)
  else
    alpha = 1 − (md * (t − dy)/t),
```

wherein,
“t” represents dimming thickness
“dx” represents inner distance from nearest vertical edge (side) of the frame
“dy” represents inner distance from nearest horizontal edge (top or bottom) of the frame
“md” represents maximum dimming value for edge-dimming.

In other implementations, edge dimming can also be performed by means of one or more image processing filters such as sharpening, blurring, or edge detection by adjusting pixel values. Further, color properties like brightness, contrast, saturation, or hue can also be altered, e.g., by applying transformations to the pixel values. As described above, system 200 modifies the pixel values of pixels identified as located in a certain a region of a frame (e.g., along the boundaries of a frame) to apply edge dimming, and the edge dimming applied modified frame is then transmitted to the display device(s) 206 for display.

In other implementations, the system 200 is configured to encode metadata pertaining to modified pixel values within the encoded video frames. This metadata can at least include the region where these pixels are located within the frame and an indication that the display device(s) 206 is to reduce the brightness of these pixels. In such implementations, the display device(s) 206 can receive this metadata and use it to apply edge dimming locally. For example, the display device(s) 206 can reduce brightness of selected pixels along each boundary of the video frame (in case of windowboxing). In another example, the display device(s) 206 can reduce brightness of selected pixels along the top and bottom boundaries of the video frame (in case of letterboxing). Other implementations are possible. The display device(s) 206 can further augment the applied edge dimming with other local display settings.

In one implementation, the metadata is transmitted by the system 200 for every frame in a vertical blanking (‘Vblank’) interval preceding the start of a vertical active (‘Vactive’) interval. The VBlank refers to the time period when the display device(s) 206 is not drawing the visible portion of a video frame. During this interval, the pixel rendering moves from the bottom of the current frame back to the top to start rendering the next frame. This period exists to ensure that the display hardware has time to reposition for the next frame's rendering. Further, VActive refers to the time when the display device(s) 206 is actively drawing a visible portion of the frame. This is the period during which the display device(s) 206 scans out pixel data and presents it to the screen, line by line, from the top to the bottom. In another implementation, the metadata is transmitted to the display device(s) 206 only when a location to which edge dimming is to be applied changes. That is, the metadata is transmitted during the VBlank interval preceding a set of frames that are identified as having the same edge dimming parameters. Once a frame with a change in edge dimming parameter is identified, e.g., based in change in content of the frame and/or change in display settings of the display device(s) 206, updated metadata is transmitted to the display device(s) 206.

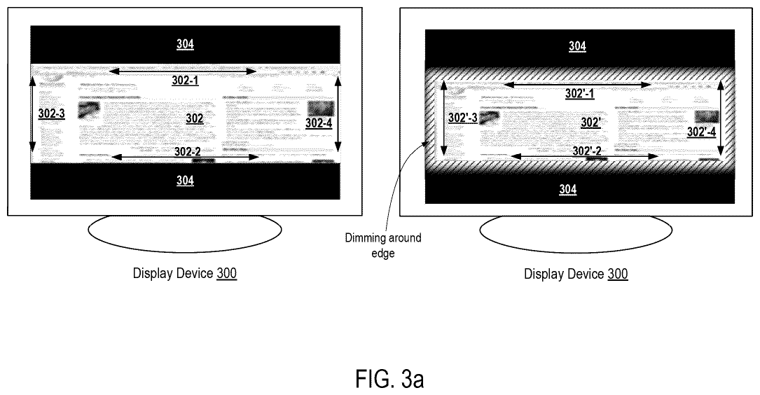

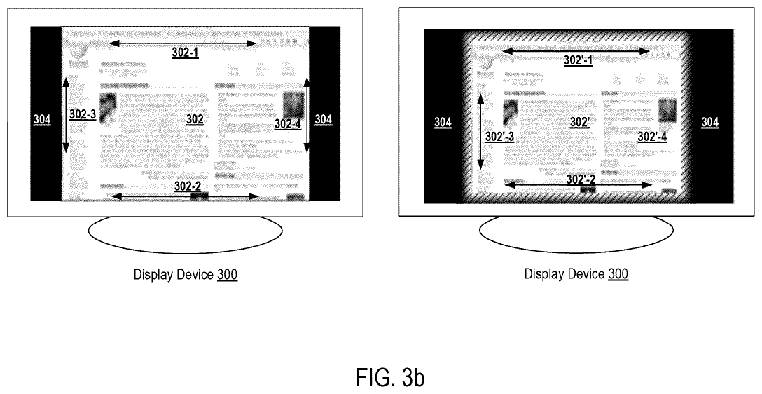

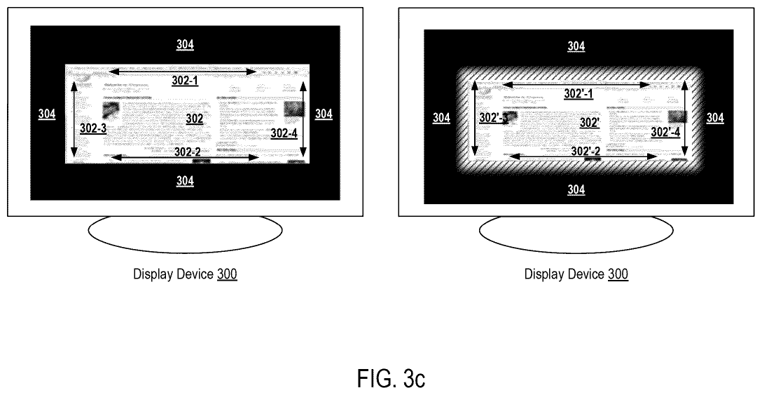

In implementations described herein, edge dimming is applied to the video frame frames and adapted, in real-time, based on identified settings of the display device(s) 206 and the content of the video frame. The methods described herein mitigate issues with non-adaptive edge dimming, by modifying pixels identified as present in various regions in a frame, instead of dimming the edges of the display itself. Only when no video streams are displayed on the display, edge dimming is applied to the full screen of the display. These implementations are described in further detail with respect to FIGS. 3-7.

FIGS. 3a-3c depict application of adaptive edge dimming for a video frame, when a video playback application is operating in a full screen mode. It is noted that the edge dimming effect shown in these figures is exaggerated for the purposes of elucidation. In real-world scenarios, the edge dimming may not be noticeable to an end user interacting with the display device. It is further noted that FIGS. 3a-3c illustrate frames being displayed on a computer monitor, however, this is done merely for the purpose of illustration. Frames can also be processed to be displayed on other display devices (TV, laptop, etc.). Such implementations are contemplated.

As described earlier, when a video playback is initiated by the video processing system (e.g., system 200) for a display device (e.g., device 206), the system renders video frames for display on the display device. The system further analyzes the video frames in real-time to cause adjustments to the frame characteristics (e.g., modification of pixel values) based on current display settings and content of video frames. In one implementation, these adjustments are made on a frame-by-frame basis, e.g., based on one or more display conditions. In one such condition, when a video player application is rendering video playback in a full screen mode, the system determines whether a video aspect ratio of a the video frame matches a display aspect ratio corresponding to the display device. That is, the system analyzes the aspect ratio of the video frame and determines if the video frame is consuming the full resolution of the display device. In the example shown in FIG. 3a, the left side of the page illustrates a video frame 302 being displayed without any edge dimming applied. As seen from the illustration, a video frame 302 is being displayed on a display device 300. In some cases, “black bars” can be displayed around two or more boundaries of the video frame 302, e.g., to avoid distorting the video by stretching or squeezing it to fit the screen. Stretching the video can cause image distortion or lost content around the edges. The black bars can be added horizontally as shown in FIG. 3a. As shown, a black bar 304 is displayed around the top boundary (302-1) of the frame 302 and the bottom boundary (302-2) of the frame 302. This is known as letterboxing. Letterboxing can be done to display content with a wider aspect ratio than the display it is being viewed on.

When a power saving mode is active or the video processing system otherwise identifies a requirement for power saving, the system modifies the video frame 302 to apply edge dimming. In order to apply edge dimming, the system first determines whether a video player application executing on the system is rendering video playback in a full screen mode or a windowed mode. This information can be identified based on the display data obtained by the system when the display device 300 first turns on. The system then analyzes the frame 302 and determines whether aspect ratio of the video frame 302 matches the aspect ratio of the display device 300, without considering the bars 304. When the playback is in full screen mode (as shown in FIG. 3a), and the aspect ratios do not match, the system modifies the video frame 302 to apply edge dimming. In one implementation, this is done by reducing brightness of pixels along certain regions of the frame 302. In the shown example, the brightness of pixels is reduced for sets of pixels around each boundary of the video frame (302-1 to 302-4). A modified video frame 302′ generated by applying edge dimming to the frame 302 is shown on the right side of the illustration. As seen from the illustration, pixels are dimmed along each boundary 302′-1 to 302′-4 of the video frame 302′. The modified video frame 302′ is conveyed to the display device 300 for display. In an implementation, adaptive edge dimming is performed by reducing pixel brightness along each boundary 302′-1 to 302′-4 of the modified video frame 302′, even when the frame 302′ is letterboxed by means of black bars 304. The modified frame 302′ is then displayed onto the display device 300.

FIG. 3b shows another example of adaptive edge dimming. In this example, the left side of the page illustrates a video frame 302 being displayed without any edge dimming. In this case, a black bar 304 is displayed around the left boundary (302-3) of the frame 302 and the right boundary (302-4) of the frame 302. This is known as pillarboxing.

In case of a power saving requirement, the system modifies the video frame 302 to apply edge dimming. To do this, the system first analyzes the frame 302 and determines whether aspect ratio of the frame 302 matches the aspect ratio of the display device 300, without considering any black bars 304. The system further determines whether the video playback is rendered in a full screen mode or a windowed mode. When the playback is in a full screen mode (as shown in FIG. 3b), the system modifies the video frame 302 accordingly to apply edge dimming. In the shown example, this is done by reducing brightness of pixels along each boundary of the video frame (302-1 to 302-4) to generate a modified frame. The modified frame 302′ generated by applying edge dimming to the frame 302 is shown on the right side of the illustration. As seen from the illustration, pixels are dimmed along each boundary 302′-1 to 302′-4 of the modified video frame 302′. In an implementation, adaptive edge dimming is performed by reducing pixel brightness along each boundary 302′-1 to 302′-4 of the frame 302′, even when the frame 302′ is pillarboxed by means of black bars 304. The modified frame 302′ is then displayed onto the display device 300.

FIG. 3c shows yet another example of adaptive edge dimming. In this example, the left side of the page again illustrates a video frame 302 displayed without any edge dimming. As seen from the illustration, for the video frame 302 displayed, black bars 304 are detected around each boundary (302-1 to 302-4) of the frame 302. This is known as windowboxing. For power saving implementations, the system is configured to modify the video frame 302 to apply edge dimming. Once again, the system determines whether the video playback is rendered in a full screen mode or a windowed mode. The system also analyzes whether the aspect ratio of the frame 302 matches the aspect ratio of the display device 300, without considering the bars 304. When the playback is in a full screen mode (as shown in FIG. 3c), and the aspect ratios do not match, the system modifies the video frame 302 accordingly to apply edge dimming.

In the shown example, this is done by reducing brightness of pixels along each boundary of the video frame (302-1 to 302-4). A modified video frame 302′ generated by applying edge dimming to the frame 302 is shown on the right side of the illustration. As seen from the illustration, pixels are dimmed along each boundary (302′-1 to 302′-4) of the video frame 302′. In this implementation, adaptive edge dimming is performed by reducing pixel brightness along each boundary (302′-1 to 302′-4) of the frame 302′, even when the frame 302′ is windowboxed by means of black bars 304. The modified video frame 302′ is then displayed onto the display device 300.

In one or more implementations, for applications where no video streams are transmitted to the display device 300 and/or when the aspect ratio of the video frame 302 matches the aspect ratio of the display device 300, the system can simply cause edge dimming to be applied to the entire full screen of the display 300. In such implementations, brightness data for each region of the display 300 is analyzed by the system, and a control signal is generated. This control signal instructs the display 300 to apply edge dimming to the full screen of the display 300. In one example, the signal is transmitted using a communication protocol like I²C (Inter-Integrated Circuit) or DDC (Display Data Channel). Applying edge dimming to a display, e.g., when no video stream is available, is used for applications with power-saving or visual quality improvement contexts. For example, when no video stream is being fed to the display 300, edge dimming can be used to reduce the overall power consumption of the display. Further, reducing the intensity of backlight around the screen edges, even in standby or idle mode, can be advantageous in saving power when no content is being displayed, especially for displays in always-on devices like smart TVs or signage systems.

FIGS. 4a-4b depict application of adaptive edge dimming for a video frame, when a video playback is rendered in a windowed mode. It is again noted that the edge dimming effect shown in the figure is exaggerated for the purposes of elucidation. Further, frames are shown as being displayed on a computer monitor, however, this is done merely for the purpose of illustration. Frames can also be processed to be displayed on other display devices (TV, laptop, etc.). Such implementations are contemplated.

As described in the foregoing, a video processing system (such as system 200) analyzes video frames in real-time, and causes adjustments to the frame characteristics (e.g., modification of pixel values) based on current display settings and content of video frames. In one such implementation, the system is configured to generate a modified video frame by modifying pixels of an encoded video frame, when the video playback application is operating in a windowed mode, i.e., a resizable playback window is used to display video.

In the example shown in FIG. 4a, the left side of the page illustrates a video frame 402 being displayed on a display device 400 using a playback window 406, without any edge dimming applied originally. As shown, a black bar 404 is identified along the top boundary (402-1) of the frame 402 and the bottom boundary (402-2) of the frame 402. The black bars 404 appear when the video frame is letterboxed, e.g., to display the video frame without stretching or distorting the video content.

The system analyzes the frame 402 and determines whether aspect ratio of the video frame 402 matches the aspect ratio of the playback window 406. When the aspect ratios do not match, the system modifies the video frame 402 to apply edge dimming by reducing brightness of pixels along certain identified regions of the frame 402. In the shown example, the frame 402 is modified to reduce brightness of pixels around each boundary (402-1 to 402-4), of the video frame 402 within the playback window 404, excluding any black bars 404. A modified video frame 402′ with edge dimming applied is shown on the right side of the page. As seen from the illustration, pixels are dimmed along each boundary 402′-1 to 402′-4 of the video frame 402′ (as shown by the shaded portion) displayed using playback window 404, even when the frame 402′ is letterboxed. In one or more implementations, the video frame 402 is modified when a power saving mode is active or the video processing system otherwise identifies a requirement for power saving for the display device 400. The modified video frame 402′ is conveyed to the display device 400 for display. Similar modifications can also be performed on other frames that are displayed using the playback window 404, e.g., including frames that are windowboxed or pillarboxed (similar to as described with respect to FIGS. 3b and 3c).

On the other hand, when aspect ratio of the video frame 402 matches the aspect ratio of the playback window 406 (i.e., no letterboxing, pillarboxing, or windowboxing is applied), the edge dimming is applied to the entire playback window 406. This is depicted in FIG. 4b. The left side of the figure illustrates the frame 402 being displayed in the playback window 406, while consuming the full resolution of the playback window (i.e., the aspect ratio of the frame 402 and the window 406 is the same). The modified frame 402′ is generated (shown on the right side), in a manner that edge dimming is applied to the entire playback window 406. As shown using shaded portions, pixels are dimmed along each boundary 402′-1 to 402′-4 of the video frame 402′ such that edge dimming is applied to the entire playback window 404.

In one or more implementations, whether aspect ratio of video frame 402 is detected as matching the aspect ratio of the playback window 404 (as shown in FIG. 4) or otherwise, the video processing system further causes edge dimming to also be applied to the entire full screen of the display 400. In an implementation, edge dimming is applied to the full screen of the display 400 by adjusting brightness around the edges of the display (as described in FIG. 2).

FIG. 5 illustrates adaptive edge dimming applied to multiple video streams displayed simultaneously. In one or more implementations, some applications can require individual video streams (e.g., video received from different video sources) to be displayed on a display device at the same time. One such implementation is a video conferencing application. During a video conferencing session, participants exchange real-time video streams using bidirectional media channels, enabling synchronous communication through encoded and transmitted audiovisual data packets over a network. In this implementation, a video stream from each participant's device can be displayed on all other participants' screens, and likewise, their video feeds are displayed on each participant's device.

In an example shown in FIG. 5, a video conferencing application being executed in a display window 506 is shown. A total of ten different video streams (502-1 to 502-10) are shown to be currently displayed for the video conferencing session, wherein 502-10 is a video stream local to the display device 500. In a situation wherein the display device 500 is in power saving mode or otherwise requires a reduction in operating power, a video processing system (such as system 200) can apply adaptive edge dimming to each individual video stream 502 based on display conditions and content of each video stream. The system analyzes each video frame in any given video stream 502, to determine whether black bars are identified in any frame, i.e., whether any frame is letterboxed, pillarboxed or windowboxed. Since each participant may have a different screen with varying aspect ratios, so the video conferencing platform ensures that the video is displayed correctly on all devices. For instance, when aspect ratio of the video does not match the display aspect ratio (e.g., showing a 4:3 feed on a 16:9 screen), black bars are added either on the sides (pillarboxing) or top and bottom (letterboxing) to fill the space without distorting the video. The system detects these black bars for each video frame of each individual window stream 502.

In addition to the comparison of aspect ratios, for each frame, the system further analyzes the current display conditions of the display device 500. In an implementation, this includes detecting when a video player application is rendering video playback in full screen mode or windowed mode. Based on these determinations, edge dimming is applied to each video stream 502. The edge dimming is applied by reducing pixel brightness (i.e., dimming the pixels) around boundaries of each frame displayed in each video stream 502. For the sake of simplicity, in the example shown in FIG. 5, edge dimming (exaggerated) is shown to applied similarly to each video stream 502. However, in other implementations, edge dimming can be applied differently to each video stream 502, based on various conditions. For instance, one or more of the video streams 502 are letterboxed, and therefore edge dimming is applied differently (as described in FIG. 3a). In other cases, a video stream 502 can be windowboxed and edge dimming is applied accordingly (as described in FIG. 3c). Such implementations are contemplated.

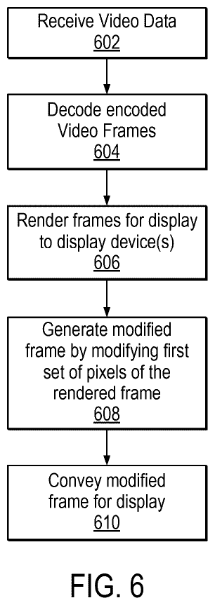

FIG. 6 depicts a method for generating modified video frames. A video processing circuitry (e.g., processor 204) first receives video data and encoded video frames from one or more video sources (block 602). In an example, the video data can at least include pixel values including information pertaining to color and brightness of each pixel. In most cases, this information includes red, green, and blue (RGB) or luma, blue-difference, red-difference (YCbCr) channel values. The data can further include alpha data that includes information pertaining to transparency or opacity of each pixel in an encoded image or video frame.

The video processing circuitry then decodes the encoded video frames (block 604), and the decoded frames are stored in a memory storage. In one or more implementations, when a video playback is initiated by the system, a display controller (e.g., controller 220) reads the decoded frame data from the memory and transmits video signals to one or more display device(s). In one or more implementations, before transmitting decoded frames to the display device(s), the system processes the decoded frames, e.g., to apply color correction, improve video quality, apply format compatibility, or for performing video analytics, etc.

In an implementation, in response to initiation of the video playback to a display device, the circuitry renders video frames for display on the display device (block 606). The circuitry further analyzes the rendered video frames in real-time to generate modified frames, e.g., by modifying a set of pixels from the decoded frame (block 608). In this implementation, the circuitry cause adjustments to the frame characteristics (i.e., modification of pixel values) based on current display settings of the display device and content of video frames. These adjustments are made on a frame-by-frame basis. For instance, video frames can be modified when one or more display conditions are met. In one such condition, if the video frame is rendered in a full screen mode, and the video processing circuitry identifies that a video aspect ratio of a given video frame does not match a display aspect ratio corresponding to the display device (e.g., in case of letterboxing), the frame is modified by applying edge dimming. In another example, when the video frame is rendered in a windowed mode and a video aspect ratio of a frame matches an aspect ratio of a playback window used to display the frame, the system applies edge dimming for the entire playback window (e.g., causes reduction of brightness of pixels along each boundary of the playback window). Edge dimming can be applied by adjusting brightness of selected pixels along each boundary (i.e., edge) of the video frame. This modification is performed in real-time, e.g., as the video frame is being rendered. The modified frames are conveyed to the display device for display (block 610).

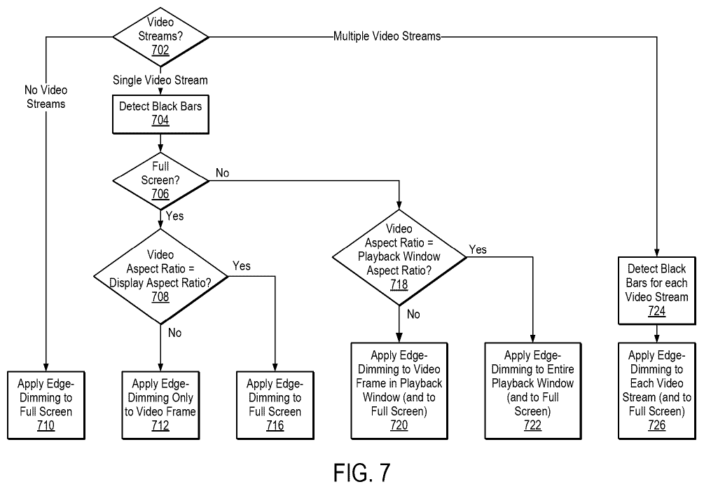

FIG. 7 illustrates a method for applying edge dimming to video streams based on one or more conditions. In one or more implementations, a video processing system processes one or more incoming video streams and applies edge dimming to the video streams, e.g., when a power reduction is required (such as when a display device operates in a power saving mode). The method begins with the system determining if one or more incoming video streams are detected (conditional block 702). If no video streams are detected (conditional block 702, “no” leg), the system applied edge dimming to the full screen of a connected display device (block 710). In these situations, the edge dimming can be applied by sending a control signal to the display device indicating that brightness of pixels around edges of the display device screen is to be reduced. In an implementation, the video processing system instructs the display to dim the edges of the screen during periods of inactivity based on pre-defined power-saving or display protection modes.

In case a single incoming video stream is detected (conditional block 702, “single video stream” leg), the system begins to analyze each frame of the video stream. For each frame, the system first detects whether black bars are present during video playback (block 704). As described in the foregoing, black bars can be detected around boundaries of video frames or images in cases where letterboxing, pillarboxing, or windowboxing is applied. The system further determines whether the video stream is rendering in a full screen mode (conditional block 706). When the video stream is rendering in a full screen mode (conditional block 706, “yes” leg), the system further detects whether a video aspect ratio of the video frame matches the display aspect ratio of the display screen without any detected black bars (conditional block 708). When the aspect ratios do not match (conditional block 708, “no” block), the system applies edge dimming only to the video frame (block 712). This is done by reducing brightness of pixels along each boundary of the video frame. A modified video frame is generated based on the applied edge dimming wherein pixels are dimmed along each boundary of the modified video frame. In this implementation, adaptive edge dimming is performed adaptively, i.e., even when two or more boundaries of the frame are surrounded by black bars (as described in FIG. 3). The modified video frame is then displayed onto the display device. When the aspect ratio matches (conditional block 708, “yes” leg), the edge dimming is applied to the entire screen of the display device (block 716). This includes reducing pixel brightness along each boundary of the display screen itself.

Referring again to conditional block 706, if the system determines that the video stream is not rendering in a full screen mode (“no” leg), i.e., the rendering is being done in a windowed mode, the system further determines whether video aspect ratio of the video frame matches an aspect ratio of a playback window used to display the video frame (conditional block 718). If the aspect ratios do not match (conditional block 718, “no” leg), edge dimming is applied to the video frame in the playback window and the full screen of the display device (block 720). To do this, the system generates a modified frame such brightness of selected pixels corresponding to each boundary of the frame is reduced, and the modified frame is displayed inside the playback window (as described in FIG. 4a). The system further applies edge dimming to the full screen of the display device.

However, if the aspect ratio of the video frame matches the aspect ratio of the playback window (conditional block 718, “no” leg), edge dimming is applied to the entire playback window and to the full screen of the display device (block 722). This is described with regards to FIG. 4b.

Referring again to conditional block 702, in case of multiple incoming video streams detected (conditional block 702, “multiple video streams” leg), e.g., in a video conferencing application, the system is again configured to detect black bars for each individual video stream (block 724). Based on this detection, the current display settings, and content of each video stream, the system applies appropriate edge dimming to each video frame of each video stream (block 726). Edge dimming, in this implementation, is further applied to the full screen of the display device.

It should be emphasized that the above-described implementations are only non-limiting examples of implementations. Numerous variations and modifications will become apparent to those skilled in the art once the above disclosure is fully appreciated. It is intended that the following claims be interpreted to embrace all such variations and modifications.

1. A processor comprising:
circuitry configured to:
receive a video frame;
responsive to meeting a condition, generate a modified video frame by modifying selected pixels of the video frame identified as corresponding to a given region of the video frame; and
convey the modified video frame to a target display device for display.

2. The processor as claimed in claim 1, wherein the condition comprises the video frame being rendered in a full screen mode.

3. The processor as claimed in claim 1, the circuitry is configured to generate the modified video frame by reducing brightness of the selected pixels of the video frame.

4. The processor as claimed in claim 1, wherein the circuitry is configured to generate the modified video frame at least in part based on a comparison of a video aspect ratio of the video frame and a display aspect ratio corresponding to the target display device.

5. The processor as claimed in claim 1, wherein the condition includes a video playback at least comprising the video frame being rendered in a windowed mode, the windowed mode at least in part displaying a resizable playback window.

6. The processor as claimed in claim 5, wherein the circuitry is configured to generate the modified video frame at least in part based on a comparison of a video aspect ratio for the video frame displayed using the playback window and an aspect ratio of the playback window.

7. The processor as claimed in claim 1, wherein the circuitry is configured to generate the modified video frame by encoding metadata within the video frame, the metadata at least in part comprising an indication that brightness for one or more pixels of the selected pixels is to be reduced by the target display device.

8. A method comprising:
receiving, from a video source by a video processing circuitry, a video frame;
responsive to meeting a condition, generating, by the video processing circuitry, a modified video frame by modifying selected pixels of the video frame identified as corresponding to a given region of the video frame; and
conveying, by the video processing circuitry, the modified video frame to a target display device for display.

9. The method as claimed in claim 8, wherein the condition includes a video playback at least comprising the video frame being rendered in a full screen mode.

10. The method as claimed in claim 8, further comprising generating, by the video processing circuitry, the modified video frame by reducing brightness of selected pixels of the video frame identified as corresponding to one or more boundaries of the video frame.

11. The method as claimed in claim 8, further comprising generating, by the video processing circuitry, the modified video frame at least in part based on a comparison of a video aspect ratio of the video frame and a display aspect ratio corresponding to the target display device.

12. The method as claimed in claim 8, wherein the condition includes a video playback at least comprising the video frame being rendered in a windowed mode, the windowed mode at least in part displaying a resizable playback window.

13. The method as claimed in claim 12, further comprising generating, by the video processing circuitry, the modified video frame at least in part based on a comparison of a video aspect ratio for the video frame displayed using the playback window and an aspect ratio of the playback window.

14. The method as claimed in claim 8, further comprising generating, by the video processing circuitry, the modified video frame by encoding metadata within the video frame, the metadata at least in part comprising an indication that brightness for one or more pixels of the selected pixels is to be reduced by the target display device.

15. A video processing system comprising:
a memory to store a video frame; and
a processor configured to:
responsive to meeting a condition, generate a modified video frame by modifying selected pixels of the video frame identified as corresponding to a given region of the video frame; and
convey the modified video frame to a target display device for display.

16. The video processing system as claimed in claim 15, wherein the condition includes a video playback at least comprising the video frame being rendered in a full screen mode.

17. The video processing system as claimed in claim 15, wherein the processor is configured to generate the modified video frame by reducing brightness of the selected pixels of the video frame identified as corresponding to one or more boundaries of the video frame.

18. The video processing system as claimed in claim 15, wherein the processor is configured to generate the modified video frame at least in part based on a comparison of a video aspect ratio of the video frame and a display aspect ratio corresponding to the target display device.

19. The video processing system as claimed in claim 15, wherein the condition includes a video playback at least comprising the video frame being rendered in a windowed mode, the windowed mode at least in part displaying a resizable playback window.

20. The video processing system as claimed in claim 19, wherein the processor is configured to generate the modified video frame at least in part based on a comparison of a video aspect ratio for the video frame displayed using the playback window and an aspect ratio of the playback window.
